(19) United States
(12) Patent Application Publication
(10) Pub. No.: US 2012/0198706 A1
(43) Pub. Date: Aug. 9, 2012

(54) BEARING UNIT AND PROTECTION COVER FOR GRASS MOWER USING SAME

(76) Inventor: An Jong Yang, Gwangju (KR)

(21) Appl. No.: 13/501,780

(22) PCT Filed: Oct. 26, 2010
(86) PCT No.: PCT/KR2010/007388

§ 371 Date: Apr. 13, 2012

(30) Foreign Application Priority Data
Oct. 26, 2009 (KR) 10-2009-0101643
Nov. 20, 2009 (KR) 10-2009-0112860

(51) Int. Cl. A01D 34/82

(52) U.S. Cl. 30/286

(57) ABSTRACT

The present invention relates to a bearing unit for protecting the blade of a grass mower and preventing a cover plate from being damaged due to a driving force of a driving motor, and a protection cover for a grass mower using the same. The protection cover for a grass mower according to the present invention, comprises: a bearing coupled with a driving shaft of a driving motor to be positioned at the lower portion of a blade so as to protect the blade mounted to the driving shaft of the driving motor, which is mounted to a working stand; a cover member coupled with the bearing and having a protection plate formed in a diameter relatively larger than the rotation diameter of the blade so as to protect the blade; a rotation supporting means for supporting the protection plate to be rotatable in a predetermined angle when the protection plate is applied with a rotational force by the driving force of the driving motor; and an interval keeping member for keeping an interval between the blade and the protection plate to be a predetermined distance or more, thereby preventing the protection plate from colliding with the blade by being bent. The bearing unit according to the present invention may increase the compatibility of the blade of the grass mower and the protection cover for the grass mower and effectively block the introduction of impurities into the bearing during mowing, thereby preventing the lifespan of the protection cover for the grass mower from decreasing due to the damage to the bearing.

### TECHNICAL FIELD

The present invention relates to a bearing unit for protecting the blade of a grass mower and preventing damage to a cover plate due to the driving force of a driving motor, and a protection cover for a grass mower using the same.

### BACKGROUND ART

A grass mower has a blade installed at a lower end of a rotation shaft of a working stand and is used in a state in which it is exposed to the outside. Thus, there is a great potential for accidents when people, including children, may carelessly come close to the mower. When the blade collides with an object on the ground during a mowing operation, accidents may often occur.

In addition, the blade may be bent or broken while colliding with the object on the ground during mowing, so that a user may miss the working stand, resulting in a secondary accident.

To address this problem, various grass mowers have been proposed, which are capable of preventing accidents by providing a safety plate at a lower portion of a blade configured to cut grass in a state in which the blade is protected, including Korean Utility Model Registration No. 214892.

However, the disclosed conventional grass mower capable of protecting a blade has a problem of causing a risk of damages occurring at a connection part between a protection plate and the blade because a rotational force derived from a driving force of a driving motor is applied to the protection plate.

To address the problem, Korean Patent Application No. 10-2009-0041732, filed by the applicant of the present invention, discloses a protection cover for a grass mower including a plate rotation support means supporting a protection plate for protecting a blade so as to be rotatable in a predetermined angle.

However, in the disclosed conventional protection cover for a grass mower, problems arise that the protection cover may be bent due to an excessive restoration force when the protection cover restores into its initial position by the restoration force of a spring, and the protection cover may collide with the blade.

In addition, since impurities may be introduced to a bearing connecting the blade of a grass mower and the protection cover coupled to a lower portion of the blade during mowing, causing damages to the bearing, it is necessary to replace the whole protection cover, incurring excessive maintenance costs

However, the grass mower has several problems of causing the protection plate to pierce into the ground surface and to be inserted into the ground when the working stand is lowered by the lapse of time during mowing or the safety plate makes contact with the ground due to worker's lack of concentration, thereby making it difficult to cut grass and lowering operation efficiency.

Korean utility model registration No. 20-0439951 discloses a grass mower proposed to overcome the problems.

However, in the disclosed conventional protection cover for a grass mower, problems arise that the protection cover may be bent due to an excessive restoration force when the protection cover restores into its initial position by the restoration force of a spring, and the protection cover may collide with the blade.

In addition, since impurities may be introduced to a bearing connecting the blade of a grass mower and the protection cover coupled to a lower portion of the blade during mowing, resulting in malfunction of the bearing, it is necessary to replace the whole protection cover, incurring excessive maintenance costs.

### DISCLOSURE OF THE INVENTION

In order to overcome the above-mentioned shortcomings, the present invention provides a bearing unit, which can extend the lifespan of a protection cover by increasing the lifespan of a bearing by minimizing introduction of impurities into the bearing during mowing, the bearing unit further including an interval keeping member for keeping an interval between a support frame and the protection cover to be a predetermined distance or greater to rotatably support the protection cover for protecting the blade and to prevent the protection plate from being bent even when the protection plate restores into its initial position by a restoration force of a spring.

The present invention also provides a protection cover for a grass mower, which can prevent impurities from being introduced into a rotation supporting part rotatably supporting a blade during removing grass and impeding smooth rotation of the blade.

The present invention also provides a protection cover for a grass mower, which includes a push preventing protrusion preventing grass cut by a blade from being pushed away from the protection cover, thereby preventing cutting efficiency and minimizing damages of the blade and a risk of user's injury by preventing the blade from piercing the ground surface and colliding with the ground or impurities on the ground.

According to an aspect of the invention, there is provided a bearing unit including a bearing; a shaft supporting member including an insertion part inserted into a hollow of the bearing so as to contact an inner wheel of the bearing, and a supporting part formed on the insertion part and having a shaft penetration hole allowing a driving shaft of a grass mower blade to penetrate the same; and a protection plate connection member coupled to a protection plate installed at a lower portion of the grass mower blade and inserted into an outer wheel of the bearing.

The protection plate connection member may include a coupling part detachably coupled to a top surface of the protection plate by a fastening member, and a cylindrical part upwardly protruding a predetermined length from the coupling part and having an inner circumferential surface contacting an outer wheel of the bearing, and the shaft supporting member further includes an extension part radially extending a predetermined length from a lower end of the insertion part so as to support a bottom surface of the bearing, and an impurity blocking part downwardly extending from a periphery of the supporting part while partially surrounding a top end of the cylindrical part, and preventing impurities from being introduced into the bearing during a mowing operation.

According to another aspect of the invention, there is provided a protection cover for a grass mower for protecting a blade installed on a driving shaft of a driving motor installed on a working stand, the protection cover including a cover member coupled to the driving shaft to be positioned at a lower portion of the blade and having a protection plate formed so as to have a larger diameter than a rotation diameter of the blade to protect the blade; and a bearing unit coupled to the cover member to allow the blade to be rotatable and including a bearing; a shaft supporting member including an insertion part inserted into a hollow of the bearing so as to contact an inner wheel of the bearing, and a supporting part formed on the insertion part and having a shaft penetration hole allowing a driving shaft of a grass mower blade to penetrate the same; and a protection plate connection member coupled to a protection plate installed at a lower portion of the grass mower blade and inserted into an outer wheel of the bearing.

The protection cover may further include a plate rotation support means for supporting the protection plate so as to be rotatable in a predetermined angle when a rotational force derived from the driving force of the driving motor is applied to the protection plate; and an interval keeping member for keeping an interval between the blade and the protection plate to be a predetermined distance or greater to prevent the protection plate from colliding with the blade when it is bent. In addition, the plate rotation support means may include a spring having one end fixed to the working stand and the other end supported to the periphery of the protection plate so as not to be interfered by the blade and supporting the protection plate so as to be rotatable in a predetermined angle, and the interval keeping member includes a protection pipe having a top end fixed to the working stand and extending to surround the spring member to have a bottom end contacting the periphery of the protection plate connected to the spring member so as to prevent the protection plate from being bent in the course of restoring into an initial position by the spring member.

The protection cover may further include an auxiliary impurity blocking part protruding a predetermined length from a top surface of the protection plate toward the blade and blocking impurities from being introduced to the driving shaft.

The protection plate may have a plurality of cutting grooves inwardly recessed from its periphery a predetermined depth and alternating with protruding parts in a radial direction, the protruding parts having a radius from the driving shaft larger than a rotation radius of the blade, a plurality of cutting holes connected up and down between ends of the cutting grooves and the bearing are radially spaced apart from each other, and the auxiliary impurity blocking part includes a bent plate bent to upwardly extend from terminal edges of the cutting holes adjacent to the bearing.

The protection plate may have a plurality of cutting grooves inwardly recessed from its periphery a predetermined depth and alternating with protruding parts in a radial direction, the protruding parts having a radius from the driving shaft larger than the rotation radius of the blade, and the auxiliary impurity blocking part includes a bent plate bent to upwardly extend from terminal edges of the cutting holes adjacent to the bearing.

The protection plate may have a plurality of cutting grooves inwardly recessed from its periphery a predetermined depth and alternating with protruding parts in a radial direction, the protruding parts having a radius from the driving shaft larger than the rotation radius of the blade, and a push preventing protrusion is formed at peripheries of ends of the cutting grooves facing the blade in a rotating direction of the blade to prevent to be-cut-grass inserted into the cutting grooves from being pushed away to the outside of the protection plate while the grass is cut by the blade.

The protection plate may have a plurality of cutting grooves inwardly recessed from its periphery a predetermined depth and alternating with protruding parts in a radial direction, the protruding parts having a radius from the driving shaft larger than the rotation radius of the blade, and a bent part upwardly bent in a predetermined angle at an exterior end of the protruding part to prevent the end of the protection plate from piercing the ground surface and being inserted into the underground during mowing.

As described above, the bearing unit according to the present invention can increase the compatibility of the blade of the grass mower and the protection cover for the grass mower and can effectively block the introduction of impurities into the bearing during mowing, thereby preventing the lifespan of the protection cover for the grass mower from decreasing due to the damage to the bearing.

In addition, the protection cover for a grass mower according to the present invention can prevent the protection cover from being deformed so as to collide with the blade by a restoration force and can block impurities from being introduced into a driving shaft, thereby facilitating driving.

### BRIEF DESCRIPTION OF THE DRAWINGS

The objects, features and advantages of the present invention will be more apparent from the following detailed description in conjunction with the accompanying drawings, in which:

FIG. 1 is a perspective view of a protection cover for a grass mower according to a first embodiment of the present invention;

FIG. 2 is an exploded perspective view of a plate rotation support means shown in FIG. 1;

FIG. 3 is a perspective view of a cover member shown in FIG. 1;

FIG. 4 is an exploded perspective view of a bearing unit;

FIG. 5 is an exploded perspective view illustrating a bearing unit according to another embodiment of the present invention;

FIG. 6 is a cross-sectional view of FIG. 5;

FIG. 7 is an exploded perspective view illustrating a bearing unit according to still another embodiment of the present invention;

FIG. 8 is a cross-sectional view of FIG. 7;

FIG. 9 is a cross-sectional view illustrating a side section of FIG. 1;

FIG. 10 is a partly cut-away perspective view of a plate rotation support means according to another embodiment of the present invention;

FIG. 11 is a perspective view of a protection cover for a grass mower according to a second embodiment of the present invention;

FIG. 12 is a plan view of a protection cover for a grass mower according to a third embodiment of the present invention; and

FIG. 13 is a side sectional view of FIG. 12.

### BEST MODE FOR CARRYING OUT THE INVENTION

Hereinafter, a bearing unit according to an embodiment of the present invention and a protection cover for a grass mower using the bearing unit will be described in detail with reference to the accompanying drawings.

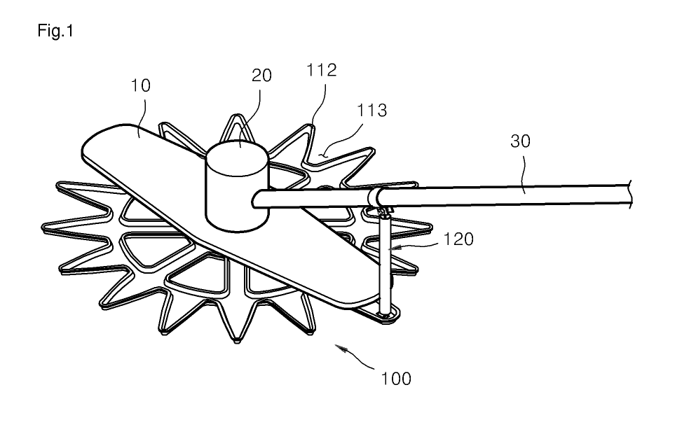

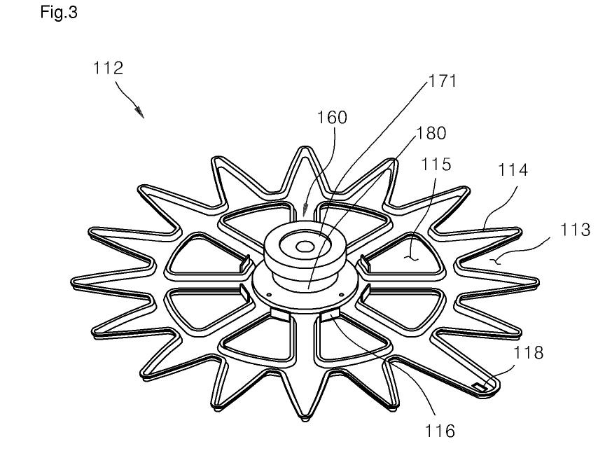

FIGS. 1 to 4 illustrate a grass mower according to a first embodiment of the present invention and a protection cover for a grass mower installed in the grass mower.

Referring to FIGS. 1 to 4, the grass mower according to the first embodiment of the present invention includes a driving motor 20 installed at an end of a working stand 30, and a blade 10 installed on a driving shaft 21 of the driving motor 20 and cutting to-be-cut grass while rotating with the driving shaft 21.

Although not shown, the grass mower may further include a switch applying a driving signal to the driving motor 20 and a driving force supply unit supplying power. The protection cover 100 includes a cover member 110 supported to the driving shaft 21 so as to be positioned at a lower portion of the blade 10, a bearing unit 160 connecting the cover member 110 to the driving shaft of the blade 10, and a plate rotation support means 120 supporting the cover member 110.

The driving shaft 21 is coupled to the cover member 110 by the bearing unit 160 so as to be rotatable and is fastened by a fastening nut 40 at a lower portion of the protection plate 112 after penetrating the bearing unit 160 and the protection plate 112.

The cover member 110 includes the protection plate 112. The bearing unit 160 is mounted on a top surface of the center of the protection plate 112. The protection plate 112 is configured such that a distance from the bearing unit 160 to the outer circumferential surface is larger than a rotation radius of the blade 10. In addition, a cutting grooves 113 recessed a predetermined depth toward the center of the protection plate 112 are formed at the periphery of the protection plate 112 to be radially spaced a predetermined distance apart from each other.

Protruding parts 114 are formed between the cutting grooves 113. Accordingly, the protection plate 112 is configured such that the cutting grooves 113 radially alternate with the protruding parts 114 formed. In addition, a plurality of penetrating holes 115 penetrating top and bottom surfaces of the protection plate 112 are formed at interior sides of the cutting grooves 113.

Since the protection plate 112 is configured such that the protruding parts 114 are longer than the rotation radius of the blade 10, the blade 10 is interfered by the protruding parts 114 before it collides with an obstacle during mowing.

Therefore, it is possible to prevent the blade 10 rotating at high speed from colliding with gravel or other foreign material to bounce toward people nearby. That is to say, it is possible to prevent the blade 10 from being damaged due to collision with obstacles other than grass.

Since the cutting grooves 113 and the penetration holes 115 are formed in the protection plate 112, the to-be-cut grass upwardly may protrude from the top surface of the protection plate 112 through the cutting grooves 113 and the penetration holes 115 and only the grass located at interior sides of the periphery of the protection plate 112 can be cut, thereby achieving a safe mowing operation.

In addition, the protection plate 112 includes an auxiliary impurity blocking part for preventing rotation of the blade 10 from being interfered due to impurities introduced to a connection point between the bearing unit 160 and the driving shaft 21 in a radial direction in which the bearing unit 160 is surrounded. In the current embodiment, bent plates 116 upwardly extending from peripheries of the penetration holes 115 are provided as the auxiliary impurity blocking part so as to be spaced apart from each other in the radial direction in which the bearing unit 160 is surrounded.

The bent plates 116 are formed by perforating the protection plate 112 so as to cut edges of portions to be bent in the course of processing the penetration holes 115 by perforation using a pressing device and bending the same.

In the current embodiment of the present invention, the auxiliary impurity blocking part may be bend in the course of processing the protection plate 112 and may include a plurality of bent plates 116 spaced a predetermined distance apart from each other. Alternatively, an annular cylinder member coupled to a top portion of the protection plate 112 may also be formed to surround the bearing unit 160.

As described above, the bearing unit 160 rotatably supports the driving shaft 21 of the blade 10 with respect to the protection plate 112.

The bearing unit 160 is installed on the protection plate 112 and includes a bearing 161, a shaft supporting member 171 making contact with the inner wheel 163 of the bearing 161, and a protection plate connecting member 181 making contact with the outer wheel 164 of the bearing 161.

The bearing 161 may be formed of a generally used ball bearing and is configured such that the inner wheel 163 and the outer wheel 164 are connected to each other by an electronically driven ball (not shown). The bearing 161 may take any type of bearing as long as it can connect the shaft supporting member 171 and the protection plate connecting member 181 so as to be rotatable.

The shaft supporting member 171 includes an insertion part 172 inserted into a hollow 162 of the bearing 161 so as to contact an inner circumferential surface of the inner wheel 163 of the bearing 161, and a supporting part 173 formed at a top end of the insertion part 172 and supporting a bottom surface of the blade 10.

A shaft penetration hole 176 is formed in the supporting part 173 to allow the driving shaft 21 to penetrate therethrough. If the driving shaft 21 is inserted to pass through the shaft penetration hole 176, the blade 10 is supported to a top surface of the supporting part 173.

In addition, an extension part 174 is provided at a lower end of the insertion part 172. The extension part 174 is coupled to the bearing 161 so as to penetrate the hollow 162 of the bearing 161 and then extends at a lower portion of the bearing 161.

Since the extension part 174 radially extends from the lower end of the insertion part 172, it supports the lower portion of the bearing 161. If the shaft supporting member 171 is coupled to the bearing 161, the bearing 161 and the shaft supporting part 173 are coupled to each other by the extension part 174 so as not to be separated from each other.

In addition, a downwardly extending impurity blocking part 175 is provided at a periphery of the supporting part 173. The impurity blocking part 175 is formed to downwardly extend a predetermined length further than a top end of a protection plate connecting member 181 to be described later. Therefore, the impurity blocking part 175 can prevent impurities from being introduced into the bearing 161 during mowing, thereby extending the lifespan of the bearing 161.

The protection plate connecting member 181 includes a coupling part 182 detachably coupled to a top surface of the protection plate 112 by a fastening member 186, and a cylindrical part 184 upwardly protruding from the coupling part 182 and having an inner circumferential surface making contact with the outer wheel 164 of the bearing 161.

The coupling part 182 has a plurality of fastening holes 183 radially spaced a predetermined distance apart from each other and the fastening member 186 couples the fastening holes 183 to a coupling hole 111 of the protection plate 112 while penetrating the coupling hole 111.

The cylindrical part 184 makes contact with the outer wheel 164 of the bearing 161 and a bent part 185 bent so as to surround a predetermined region of the top surface of the bearing 161 is provided at a top end of the cylindrical part 184.

If the blade 10 rotates, the blade 10 and the driving shaft 21 rotate with the shaft supporting member 171 making contact with the inner wheel 163 of the bearing 161.

The protection plate 112 is connected to the protection plate connecting member 181 making contact with the outer wheel 164 of the bearing 161. Thus, only the blade 10 may rotate while the cover member 110 does not rotate.

Since the bearing unit 160 is provided with only the hollow 162 through which the driving shaft 21 penetrates, the driving shaft 21 is integrally formed with the blade 10. Thus, the bearing unit 160 may be fixed to the protection plate 112 by a separate nut at a lower portion of the protection plate 112. Alternatively, a fastening pin may be inserted into the protection plate 112 from its lower portion to its upper portion to be threaded with the blade 10.

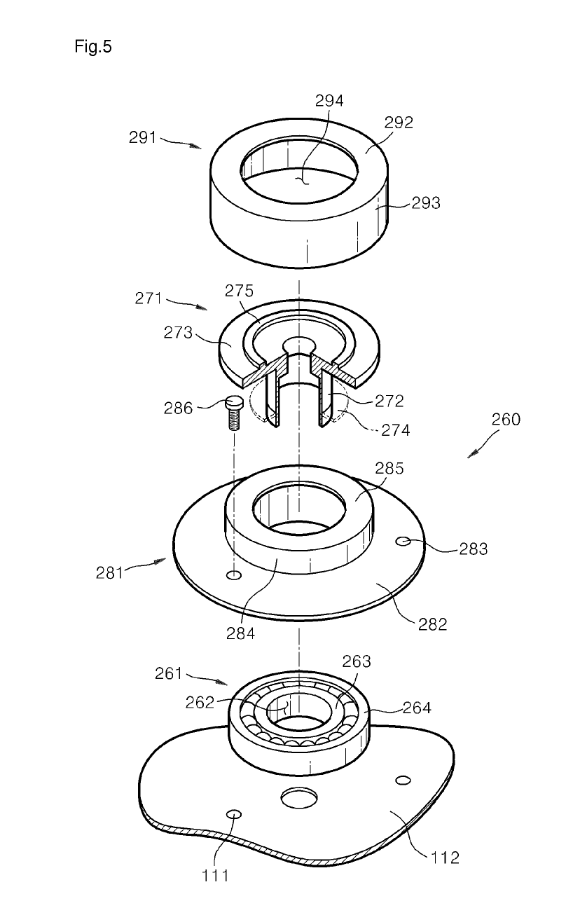

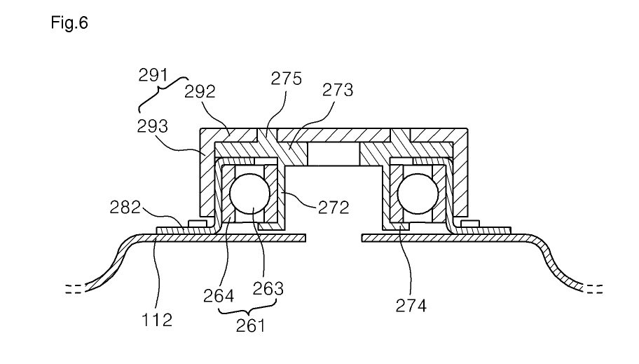

FIGS. 5 and 6 illustrate a bearing unit 260 according to another embodiment of the present invention.

The bearing unit 260 according to the current embodiment includes a bearing 261, a protection plate connecting member 281, a shaft supporting member 271 and a cover member 291.

The bearing 261 has an inner wheel 263 and an outer wheel 234. A hollow 262 is formed in the inner wheel 263 such that a rotation shaft of a blade is inserted into the hollow 262.

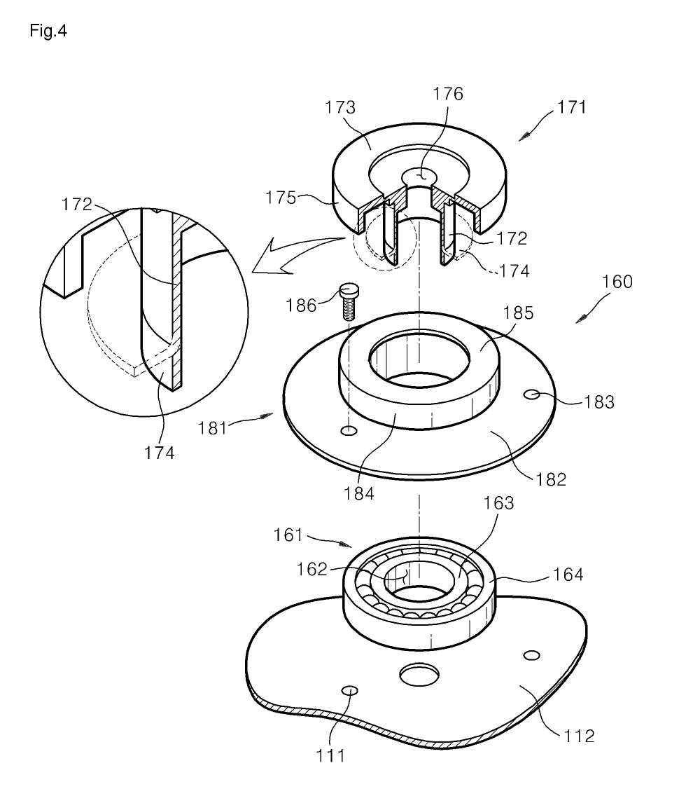

The protection plate connecting member 281 includes a coupling part 282, a cylindrical part 284 and a bent part 285, like in the embodiment shown in FIG. 4.

The shaft supporting member 271 is different from the shaft supporting member 171 of the embodiment shown in FIG. 4 in that the impurity blocking part 175 is not formed and an upwardly protruding protrusion 275 radially extend on a top surface of a supporting part 273. Since an outer diameter of the protrusion 275 is smaller than a peripheral diameter of the supporting part 273, a bump is formed around the periphery of the protrusion 275.

An insertion part 272 inserted into the hollow 262 of the bearing 261 is provided in the shaft supporting member 271 according to the current embodiment. A bottom end of the insertion part 272 spreads outwardly, forming an extension part 274, thereby supporting a bottom end of the bearing 261.

A cover member 291 is installed to surround the shaft supporting member 271 and blocks impurities from being introduced to the bearing 261. The cover member 291 includes a top cover 292 mounted on a top surface of the supporting part 273 and a side cover 293 downwardly extending from the periphery of the top cover 292.

Since the top cover 292 has a central hole 294 corresponding to the outer diameter of the protrusions 275, the protrusion 275 is inserted into the central hole 294 when the top cover 292 is mounted on the supporting part 273. In addition, the side cover 273 downwardly extends to get close to the coupling part 282 of the protection plate connecting member 281, thereby blocking external impurities from being introduced to the bearing 261. Even if the external impurities are introduced to the bearing 261, they can be easily removed by separating the cover member 291 from the bearing unit 260.

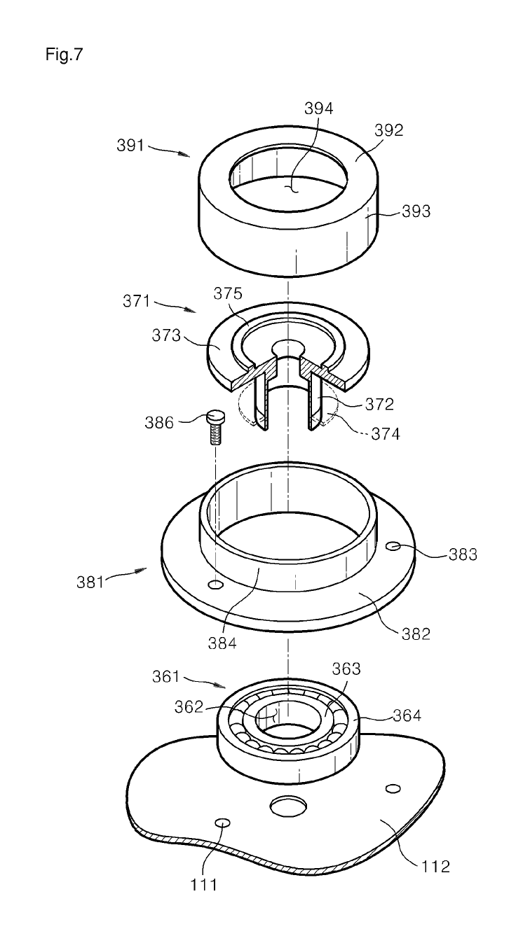

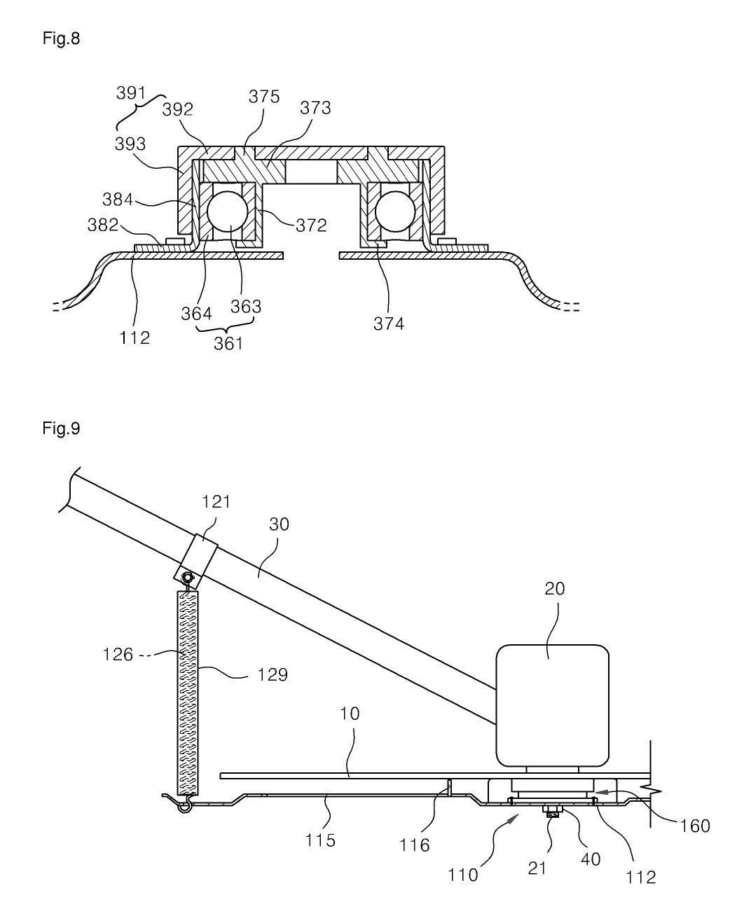

FIGS. 7 and 8 illustrate a bearing unit 360 according to still another embodiment of the present invention.

The bearing unit 360 according to the current embodiment includes a bearing 361, a shaft supporting member 371 and a cover member 391, which are basically the same as the previous embodiments of the present invention.

However, in the current embodiment, a protection plate connecting member 381 is configured such that a cylindrical part 384 without a bent part upwardly extends to a height corresponding to a top surface of the shaft supporting member 371. Therefore, since the protection plate connecting member 381 is positioned to be adjacent to a bottom surface of the top cover 392 of the cover member 391, a gap through which impurities may be introduced into to the bearing 361 can be considerably reduced, thereby more effectively increasing an impurity blocking effect.

As shown in FIG. 9, the plate rotation support means 120 includes a spring member 126 having one end and the other end connected to a working stand 30 and a protection plate 112, and a protection pipe 129 surrounding the spring member 126.

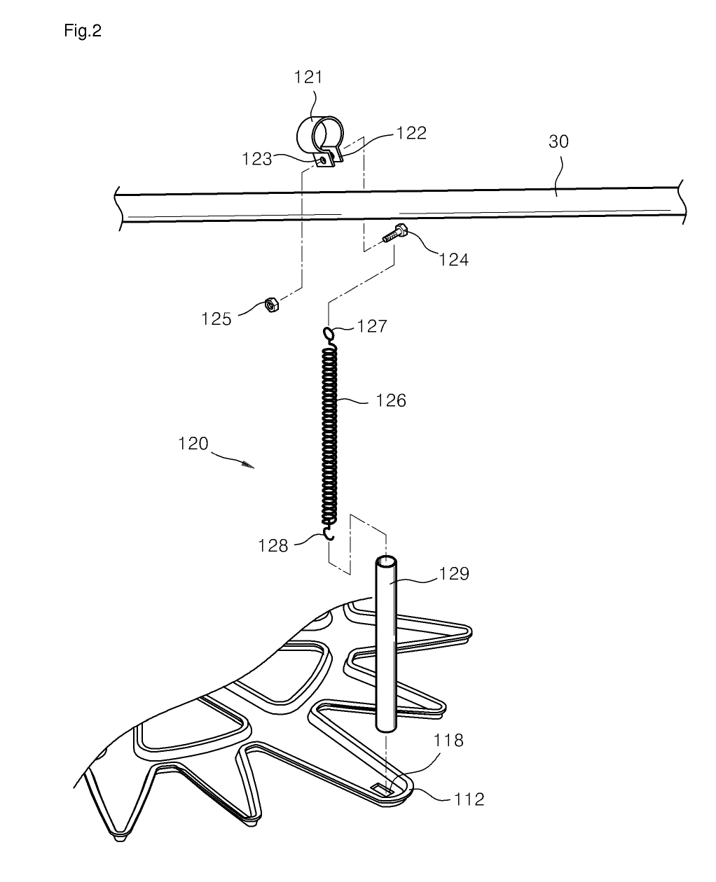

Referring back to FIG. 2, a fixing bracket 121 is installed in the working stand 30 and is configured to surround the working stand 30. Both ends of the fixing bracket 121 protrude in parallel with each other, forming fastening parts 122, and a fastening hole 123 is formed in each of the fastening parts 122.

The fixing bracket 121 is fixed by a fastening bolt 124 and a fastening nut 125. The fastening bolt 124 penetrates and is inserted into the fastening holes 123 and an end of the fastening bolt 124 is fastened with the fastening nut 125, thereby fixing the fixing bracket 121 to the working stand 30.

First and second fixing loops 127 and 128 are formed at top and bottom ends of the spring member 126. The first fixing loop 127 is hung on the fastening bolt 124 to then be fixed. The second fixing loop 128 is fitted into a fixing hole 118 formed in the protection plate 112 to then be supported.

When the blade 10 rotates at high speed by the spring member 126, the protection plate 112 is driven to be rotatable in a predetermined angle, thereby preventing the protection plate 112 from being damaged. The rotated protection plate 112 returns into its original position by a restoration force of the spring member 126.

In the current embodiment, the spring member 126 is provided to offer an elastic force to make the rotated protection plate 112 return into its initial position. In addition to the spring member 126, various elastically deformable members, such as a rubber rope that can be extended by a predetermined length, may be used.

The protection pipe 129 is installed to surround the spring member. A top end of the protection pipe 129 is supported to the fixing bracket 121 and a bottom end of the protection pipe 129 is supported to a top surface of the protection plate 112.

The protection pipe 129 is used as an interval keeping member for keeping a distance between the protection plate 112 and the blade 10 while protecting the spring member 126.

In the course of returning to an initial position by the restoration force of the spring member 126 after the protection plate 112 is rotated a predetermined angle, an excessive attraction of the spring member 126 may be applied to the protection plate 112. In such a case, one side of the protection plate 112 connected to the spring member 126 may be lifted upwardly, resulting in deformation.

If the deformation in which the one side of the protection plate 112 is upwardly lifted occurs, the blade 10 may collide with the protection plate 112. Like in the current embodiment, if the protection plate 112 is supported through the protection pipe 129 having a predetermined length, it is possible to prevent the protection plate 112 from being upwardly lifted by the protection pipe 129.

In the current embodiment, the protection pipe 129 is used as the interval keeping member for keeping the interval between the blade 10 and the protection plate 112 to be constant. However, in addition to the protection pipe 129, various types of interval keeping members may also be used.

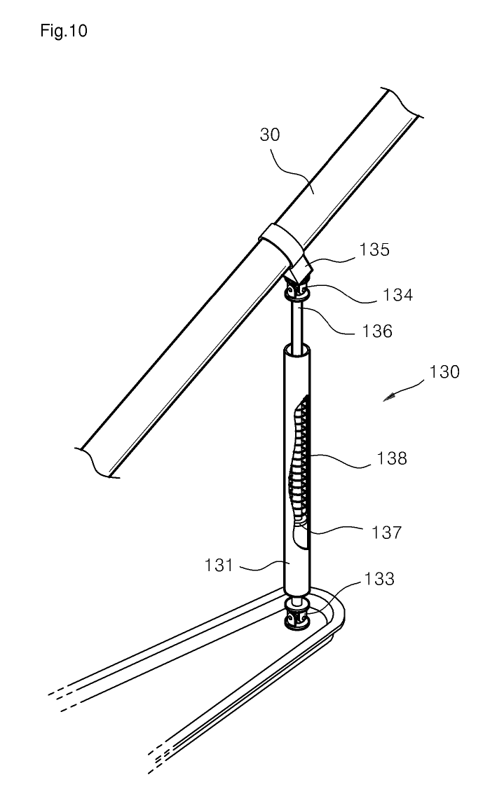

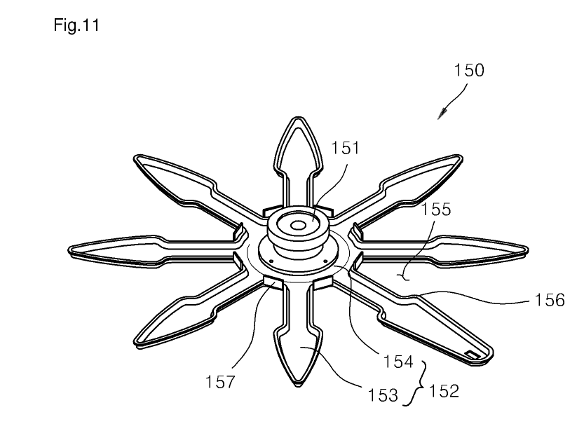

In a case where the protection plate 112 has sufficiently high strength and no deformation occurs, the protection pipe 129 may not be installed. The plate rotation support means 130 may be formed in such a manner as shown in FIG. 10.

As shown in FIG. 10, the plate rotation support means 130 includes a supporting rod 131 having one end coupled to the protection plate 112, an extracting rod 136 installed to be inserted into or extracted from the supporting rod 131, and an elastic member 138 installed in the supporting rod 131.

The supporting rod 131 has a hollow 132 extending in a lengthwise direction to allow the extracting rod 136 to be inserted into or extracted from the supporting rod 131. The hollow 132 has a top opening. The other end of the supporting rod 131 is coupled to the protection plate 112 to be rotatable by a first universal joint 133.

A top end of the extracting rod 136 is connected to the fixing bracket 135 installed in the working stand 30 by a second universal joint 134, thereby making the extracting rod 136 rotate freely.

A bottom end of the extracting rod 136 is positioned inside the supporting rod 131, and an extension plate 137 having a diameter corresponding to an inner diameter of the hollow 132 of the supporting rod 131 is provided at an end of the extracting rod 136. Since the extracting rod 136 has the diameter smaller than the inner diameter of the hollow 132, a predetermined space is formed between an inner wall of the supporting rod 131 and the extracting rod 136.

The elastic member 138 is installed inside the supporting rod 131 to elastically bias the extracting rod 136 toward the bottom end of the supporting rod 131 in a direction in which the elastic member 138 is inserted.

One end of the elastic member 138 is supported to the extension plate 137 and the other end thereof is a compression spring supported to a locking flange (not shown) provided at the top end of the supporting rod 131. When an external force is not present due to an elastic force of the elastic member 138, the overall length of the supporting rod 131 and the extracting rod 136 respectively connected to the protection plate 112 and the working stand 30 is kept at the minimum.

When the blade rotates as the grass mower is driven, the protection plate is kept at a supported state while rotating in a predetermined angle, like the plate rotation support means 120 of the first embodiment of the present invention.

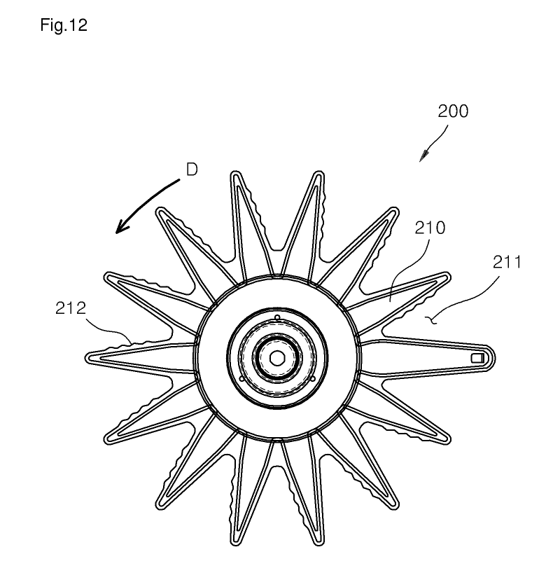

FIG. 11 illustrates a cover member for a grass mower according to a second embodiment of the present invention.

The cover member 150 according to the current embodiment includes a bearing unit 151 into which a driving shaft is inserted and a protection plate 152.

The protection plate 152 includes a base plate 154 supporting the bearing unit 151 and a plurality of protruding parts 153 radially extending from the base plate 154. Each of the protruding parts 153 is longer than the blade 10. Thus, an obstacle on the ground, such as gravel, may be earlier interfered by the protection plate 152 than by the blade 10. A plurality of cutting grooves 155 recessed toward the base plate 154 are formed between the protruding parts 153.

Since recessed depths of the cutting grooves 155 in the protection plate 152 according to the current embodiment are longer than those in the protection plate 112 according to the first embodiment, mowing taller plants than general grass or lawn such as silver grass can be more effectively facilitated.

In particular, stoppers 156 protruding toward the cutting grooves 155 are provided at locations spaced a predetermined length apart from ends of the protruding parts 153 to the base plate 154, thereby easily cutting grass introduced into the cutting grooves 155 without deviating.

In the protection plate 152 according to the current embodiment, bent plates 157 upwardly protruding at the peripheral ends of the cutting grooves 155 are used as auxiliary impurity blocking parts, and the formation method and shape thereof are the same as those of the previous embodiment.

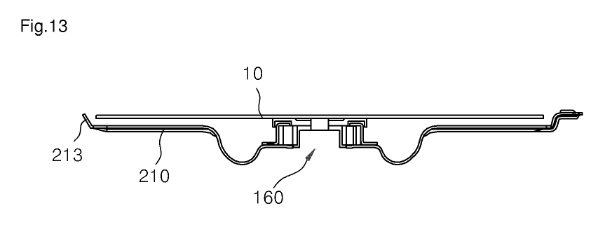

FIGS. 12 and 13 illustrate a protection cover 200 for a grass mower according to a third embodiment of the present invention.

FIGS. 12 and 13 are a plan view and a side sectional view of a protection cover 200 for a grass mower according to a third embodiment of the present invention.

Referring to FIGS. 12 and 13, the protection cover 200 includes a protection plate 210 having cutting grooves 211 recessed from the periphery to the center having a bearing, like in the second embodiment.

In addition, push preventing protrusions 212 are continuously formed at one side facing a rotation direction D of the blade 10 from the peripheral ends of the cutting grooves 211 to the center.

The push preventing protrusions 212 perform the same function as the stoppers 156 of the second embodiment. That is to say, the push preventing protrusions 212 prevent cutting of grass from being interfered due to the grass deviating from the cutting grooves 211 during mowing.

In the current embodiment, a plurality of push preventing protrusions 212 are continuously formed by a predetermined length from interior sides of the cutting grooves 211 to the peripheries. Therefore, it is possible to minimize the grass from being pushed away during mowing.

In addition, a bent part 213 upwardly bent in a predetermined angle is provided at an end of the protection plate 210. The bent part 213 prevents the end of the protection plate 210 from piercing into the underground during mowing. It is often the case that the mowing is performed in a state in which the blade 10 and the protection plate 210 are slanted and the end of the protection plate 210 may pierce into the ground surface. However, the bent part 213 can prevent the blade 10 from colliding with an obstacle on the ground, such as gravel.

Therefore, according to the present invention, the protection plate 210 can be prevented from piercing into the ground during mowing by forming the bent part 213.

Although not shown, plate rotation support means may be provided in the protection cover 200 for a grass mower according to the second and third embodiments.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

What is claimed is:

1. A bearing unit comprising:
a bearing;
a shaft supporting member including an insertion part inserted into a hollow of the bearing so as to contact an inner wheel of the bearing, and a supporting part formed on the insertion part and having a shaft penetration hole allowing a driving shaft of a grass mower blade to penetrate the same; and
a protection plate connection member coupled to a protection plate installed at a lower portion of the grass mower blade and inserted into an outer wheel of the bearing.

2. The bearing unit of claim 1, wherein the protection plate connection member includes a coupling part detachably coupled to a top surface of the protection plate by a fastening member, and a cylindrical part upwardly protruding a predetermined length from the coupling part and having an inner circumferential surface contacting an outer wheel of the bearing, and the shaft supporting member further includes an extension part radially extending a predetermined length from a lower end of the insertion part so as to support a bottom surface of the bearing, and an impurity blocking part downwardly extending from a periphery of the supporting part while partially surrounding a top end of the cylindrical part, and preventing impurities from being introduced into the bearing during a mowing operation.

3. A protection cover for a grass mower for protecting a blade installed on a driving shaft of a driving motor installed on a working stand, the protection cover comprising:
a cover member coupled to the driving shaft to be positioned at a lower portion of the blade and having a protection plate formed so as to have a larger diameter than a rotation diameter of the blade to protect the blade; and
a bearing unit coupled to the cover member to allow the blade to be rotatable and including a bearing; a shaft supporting member including an insertion part inserted into a hollow of the bearing so as to contact an inner wheel of the bearing, and a supporting part formed on the insertion part and having a shaft penetration hole allowing a driving shaft of a grass mower blade to penetrate the same; and a protection plate connection member coupled to a protection plate installed at a lower portion of the grass mower blade and inserted into an outer wheel of the bearing.

4. The protection cover of claim 3, further comprising:
a plate rotation support means for supporting the protection plate so as to be rotatable in a predetermined angle when a rotational force derived from the driving force of the driving motor is applied to the protection plate; and
an interval keeping member for keeping an interval between the blade and the protection plate to be a predetermined distance or greater to prevent the protection plate from colliding with the blade when it is bent.

5. The protection cover of claim 4, wherein the plate rotation support means including a spring having one end fixed to the working stand and the other end supported to the periphery of the protection plate so as not to be interfered by the blade and supporting the protection plate so as to be rotatable in a predetermined angle, and the interval keeping member includes a protection pipe having a top end fixed to the working stand and extending to surround the spring member to have a bottom end contacting the periphery of the protection plate connected to the spring member so as to prevent the protection plate from being bent in the course of restoring into an initial position by the spring member.

6. The protection cover of claim 3, further comprising an auxiliary impurity blocking part protruding a predetermined length from a top surface of the protection plate toward the blade and blocking impurities from being introduced to the driving shaft.

7. The protection cover of claim 6, wherein the protection plate has a plurality of cutting grooves inwardly recessed from its periphery a predetermined depth and alternating with protruding parts in a radial direction, the protruding parts having a radius from the driving shaft larger than a rotation radius of the blade, a plurality of cutting holes connected up and down between ends of the cutting grooves and the bearing are radially spaced apart from each other, and the auxiliary impurity blocking part includes a bent plate bent to upwardly extend from terminal edges of the cutting holes adjacent to the bearing.

8. The protection cover of claim 6, wherein the protection plate has a plurality of cutting grooves inwardly recessed from its periphery a predetermined depth and alternating with protruding parts in a radial direction, the protruding parts having a radius from the driving shaft larger than the rotation radius of the blade, and the auxiliary impurity blocking part includes a bent plate bent to upwardly extend from terminal edges of the cutting holes adjacent to the bearing.

9. The protection cover of claim 3, wherein the protection plate has a plurality of cutting grooves inwardly recessed from its periphery a predetermined depth and alternating with protruding parts in a radial direction, the protruding parts having a radius from the driving shaft larger than the rotation radius of the blade, and a push preventing protrusion is formed at peripheries of ends of the cutting grooves facing the blade in a rotating direction of the blade to prevent to be-cut-grass inserted into the cutting grooves from being pushed away to the outside of the protection plate while the grass is cut by the blade.

10. The protection cover of claim 3, wherein the protection plate has a plurality of cutting grooves inwardly recessed from its periphery a predetermined depth and alternating with protruding parts in a radial direction, the protruding parts having a radius from the driving shaft larger than the rotation radius of the blade, and a bent part upwardly bent in a predetermined angle at an exterior end of the protruding part to prevent the end of the protection plate from piercing the ground surface and being inserted into the underground during mowing.
